(19) United States
(12) Patent Application Publication
(10) Pub. No.: US 2018/0165981 A1
(43) Pub. Date: Jun. 14, 2018

(54) AUTOMATED TECHNIQUES FOR TEACHING LANGUAGE

(71) Applicant: GATE System, Burbank, CA (US)

(72) Inventor: Pamela Donnelly, Malibu, CA (US)

(21) Appl. No.: 15/842,773

(22) Filed: Dec. 14, 2017

Related U.S. Application Data
(60) Provisional application No. 62/434,028, filed on Dec. 14, 2016.

(51) Int. Cl. G09B 7/12; G09B 5/06; G09B 7/077; G09B 19/00; G06F 3/0486

(52) U.S. Cl. CPC G09B 7/12; G09B 5/065; G06F 3/0482; G09B 19/00; G06F 3/0486; G09B 7/077

(57) ABSTRACT

Techniques are described herein for automating the teaching of language arts in a manner that directly engages students. In one embodiment, a display device of a computer system, as part of a first automated activity, displays a definition of a particular word without depicting the particular word itself. A plurality of draggable prefixes, roots and suffixes that belong to the particular word are displayed. A first position, on the screen display, is established to which a user may drag one of the draggable prefixes. A second position, on the screen display, is established to which the user may drag one of the draggable roots. A third position, on the screen display, is established to which the user may drag one of the draggable suffixes. In response to the user dragging a particular draggable prefix to the first position, dragging a particular draggable root to the second position, and dragging a particular suffix to the third position, the system generates an indication of success if the particular word is formed by combining the particular draggable prefix, the particular draggable root, and the particular draggable suffix.

### CROSS-REFERENCE TO RELATED APPLICATIONS; BENEFIT CLAIM

This application claims the benefit of Provisional Appln. 62/434,028, filed Dec. 14, 2016, the entire contents of which is hereby incorporated by reference as if fully set forth herein, under 35 U.S.C. § 119(e).

### FIELD OF THE INVENTION

The present invention relates to automated teaching techniques and, more specifically, automated techniques for teaching language arts.

### BACKGROUND

Using traditional teaching methods, a teacher stands in front of a class and gives a lecture. The students are expected to listen attentively and take notes. Unfortunately, these traditional techniques are not optimal, because they do not account for differences in each student's ability to capture what is being taught. Thus, some students may become bored, while others cannot keep up. Further, traditional teaching techniques do not directly engage each student, so students find it hard to maintain the degree of attention required to capture the subject matter.

Fortunately, computerized systems have been developed to assist in the learning process. For example, it is common for students to use computing devices to search for information about the subject matter they are studying. In some cases, entire schools and universities are partially or completely “online”.

Even in online schools, the teaching often mirrors what has been done traditionally. For example, a user may watch a video of a teacher giving a lecture. In cases where the computers are merely used to deliver the same type of experience that students have previously experienced in-person, the school may be more convenient but not necessarily more effective.

Rather than simply deliver videos of conventional lectures, some computer applications have been developed to provide a personalized teaching. For example, systems exist for teaching math using an automated tutorial system. Because math has well-defined rules where any given answer is clearly right or wrong, computerized systems are fairly effective teachers. However, computerized teaching of other subject matter is not always so straightforward. Thus, it is desirable to provide a computerized teaching system that is effective in teaching language arts in a manner that engages the student and allows students to proceed at their own pace.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram of a computer system that interacts with an automated teaching system, according to an embodiment;

FIG. 2 is a block diagram that depicts a table, displayed on a computer screen, for the study of prefixes, roots and suffixes, according to an embodiment;

FIG. 3 is a screenshot for a first activity for teaching prefixes, roots and suffixes, according to an embodiment;

FIG. 4 is a screenshot displayed at the end of the first activity, according to an embodiment;

FIG. 5 is a screenshot for the start of an activity 2, which involves words that have only two Latin or Greek prefixes, roots or suffixes, according to an embodiment;

FIG. 6 is a screenshot displayed when a user is engaged in activity 2, according to an embodiment;

FIGS. 7A-C are collectively a screenshot displayed for an Activity 3, during which students are tested on two- and three-part words, according to an embodiment;

FIG. 8 is a screenshot of a video to show the classroom-style way in which the 2,000 Must-Know activity is taught, according to an embodiment;

FIG. 9 is screenshot of a screen in which a video is presented when a student moves onto the 2,000 must-know vocabulary list, according to a embodiment;

FIG. 10 is a screenshot showing the beginning of a 2,000 must-know vocabulary list, according to an embodiment;

FIGS. 11A-11C are screenshots relating to a fill-in-the-blank quiz presented to students after the students have mastered written flashcards, according to an embodiment; and

FIG. 12 is a block diagram of a computer system upon which an embodiment of the automated language teaching techniques may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are described herein for automating the teaching of language arts in a manner that directly engages students. In one embodiment, the software module programmed to automate the teaching of language arts is entitled “Digging For Roots”, and teaches according to the following algorithm:
A list of questions is maintained in database along with the correct prefix, root and suffix. When a student selects “digging for roots”, a randomizer function is initiated to display all the word parts in random fashion on the user interface. The word parts consist of prefix, roots and suffix along with their explanation.
A list of questions is presented to the student. Against each question, 3 boxes are provided for the student to drag and drop the appropriate word part. When all the word parts are filled for a question, a database query is initialized to check the correctness.
If the database returns true, the question and the word parts are highlighted indicating the student that the answer is correct. In case of a wrong answer, all the word parts are removed from the boxes and will be back in the random UI area.

Each step in the algorithm shall be described hereafter in greater detail.

### System Overview

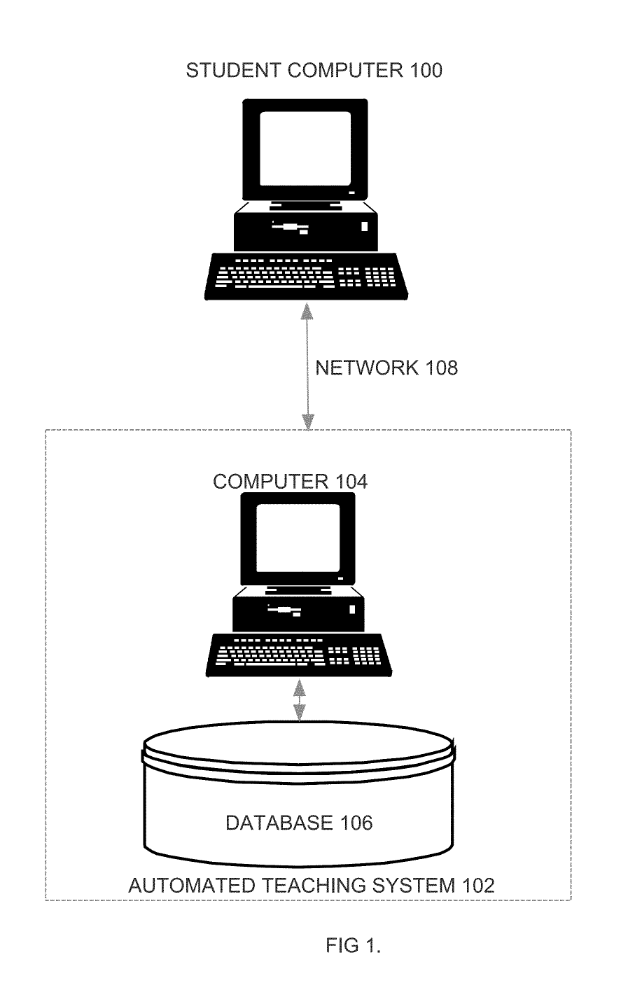

The automated techniques for teaching language arts that are described herein may be implemented on any computer system, such as the one illustrated in FIG. 1. Referring to FIG. 1, it is a block diagram of a computer system (student computer 100) that interacts with an automated teaching system 102 over a network 108. Network 108 may be the Internet, or any other communication channel that allows student computer 100 to communicate with the automated teaching system 102. Alternatively, the automated techniques described herein may be encoded in an application that is directly installed on student computer 100, thereby obviating the need for student computer 100 to communicate with another system.

In the case where student computer 100 does communicate with a separate automated teaching system 102, the automated teaching system 102 may include any number of computing devices (generally represented by computer 104), including a web server designed to receive and respond to HTTP requests from student computers, and a database server operatively coupled to a database 106.

### Overview of Training

Students who may never study Latin nonetheless get a user-friendly understanding of the building blocks of words that are destined to impact their aptitude in English classes as well as social studies, science, and more. This digitally coded training consists of an innovative drag and drop game comprised of important prefixes, roots, and suffixes. Once completed with the drag-and-drop game, students move into a 2,000-word vocabulary list of GATE's Must-Know Vocab for college-bound students, which builds on the drag-and-drop game in order to maximize their ability to see, recognize and properly decode erudite diction.

### User Flow

Below details the chronological flow in which a user would experience the Digging for Roots platform and includes mention of both content present and what user expects to gain. Screenshots have been provided for easy visualization of this activity.

Step 1:

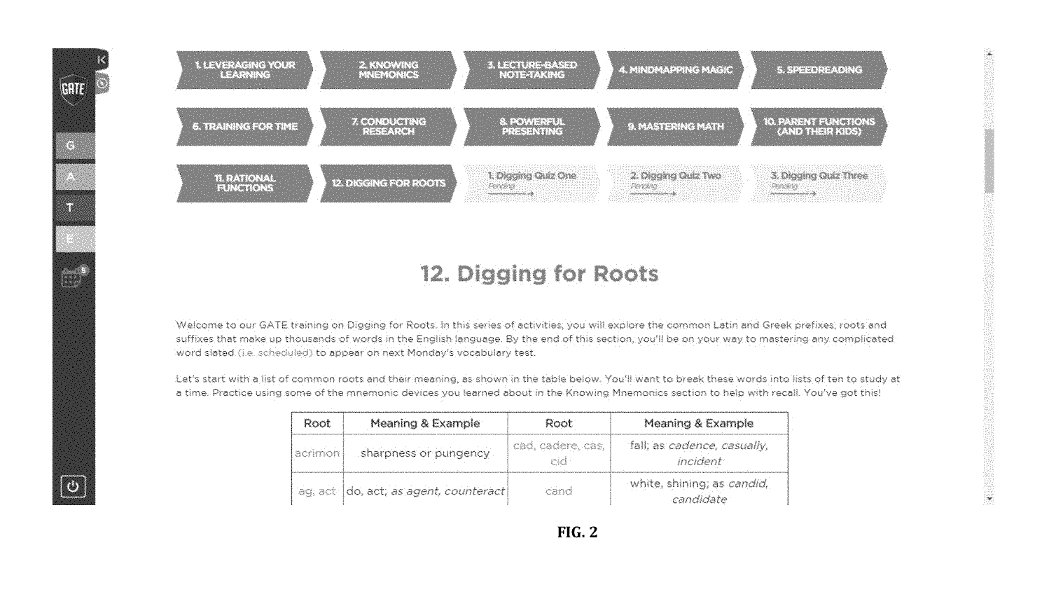

User clicks on the Digging for Roots training, which reveals 1) the quiz (i.e. scored activities) names and numbers at the top, and 2) the beginning of the training on the screen below. According to one embodiment, three scored activities in Digging for Roots accompany both a written training and video. Students start with a brief introduction to the training, mapping out what they will learn and why, then move on to studying their prefixes, roots and suffixes as shown in the table depicted in FIG. 2.

Step 2:

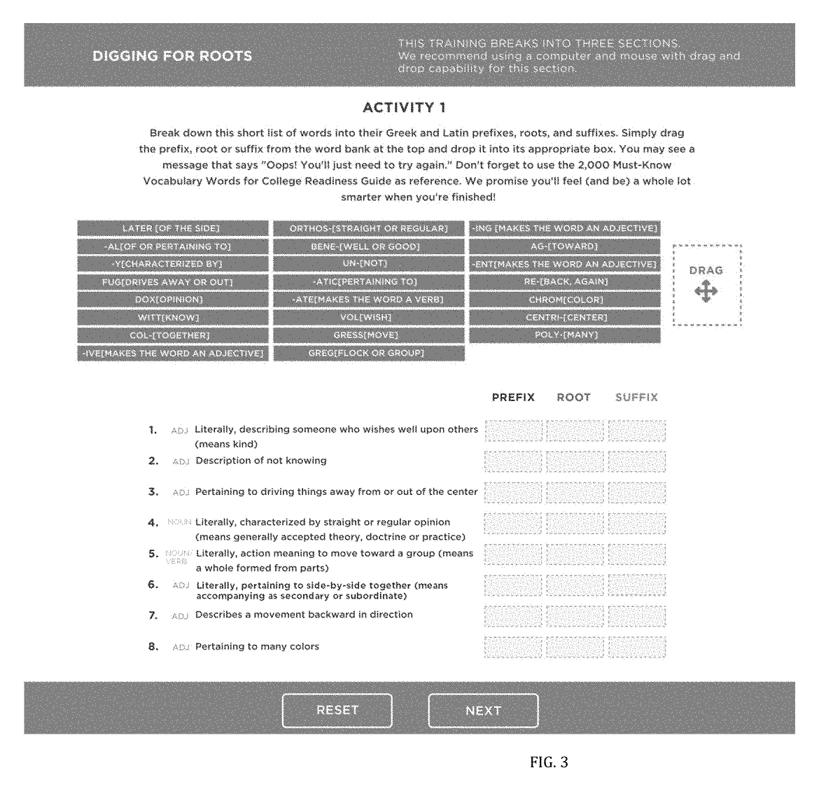

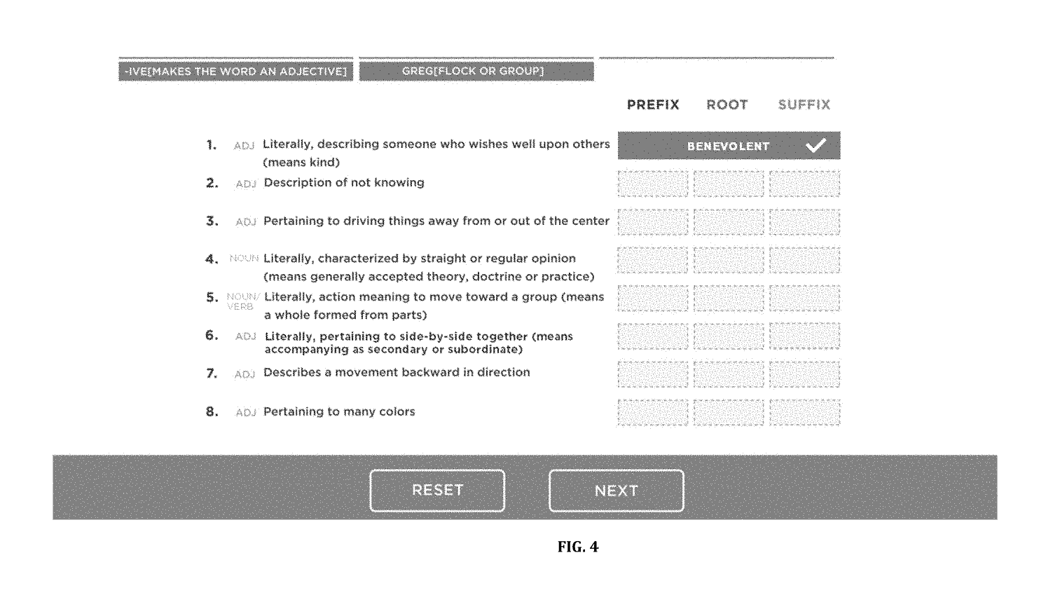

Once a student is done reading through the written training and practicing the prefixes, roots and suffixes they've been given, the automated system (“GATE”) tests their knowledge with the first quiz, a drag-and-drop activity. In this activity, students are presented with draggable prefixes, roots and suffixes that uniquely belong to a particular word. At the beginning of the activity, only the definition of this word is given—not the word itself—so students must piece together their knowledge of the overall definition with the prefix/root/suffix meanings to discover the word. A screenshot of the first activity is illustrated in FIG. 3.

As an example, a student would look at the first definition and see the intended word is an adjective that means, “Literally, someone who wishes well upon others (means kind).” Using this definition, a student would then look for prefixes and roots that fit with this given meaning. The word parts “bene” and “vol” indicate “well or good” and “wish,” respectively. Since “bene” has a hyphen immediately after it, this signifies it will belong in the first column as a prefix. Since the word part “vol” has no hyphen, this indicates it will belong in the middle column as a root. Finally, there are a few suffixes that “make the word an adjective.” At this point, the student would need to either recognize the correct suffix based on the first two parts or refer to the 2,000 Must-Know Vocabulary document (refer to Step 6 for further detail) provided at the end of the training to locate the word. The only real word that can be formed with “benevol” ends in “-ent” (i.e. not in -ing or -ive, the only other two possibilities). Note again the hyphen preceding the word part signifies that it is a suffix.

Step 3:

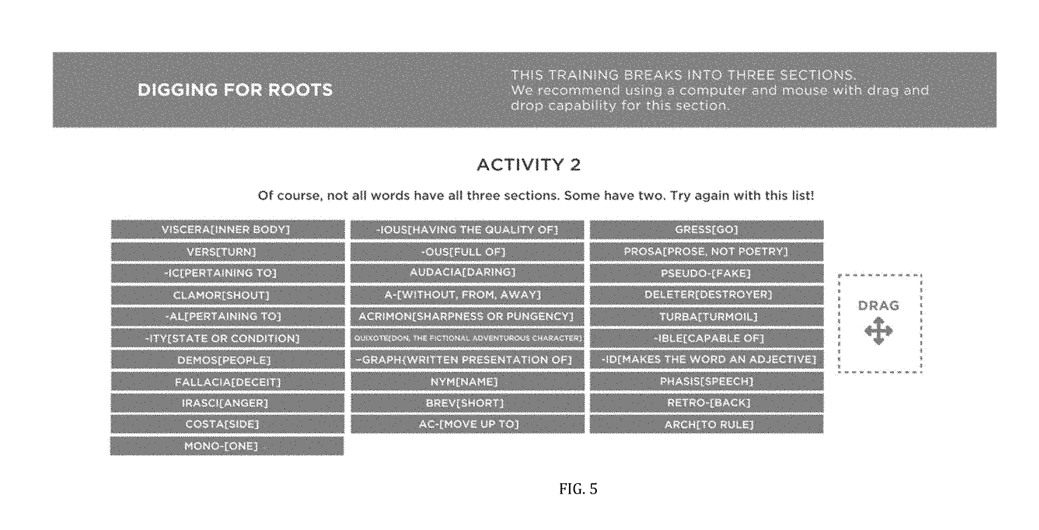

Once a student has dragged the correct word parts in their respective locations, the word parts combine, forming the whole word (see FIG. 4 for how this will look). If a word part is not correct, no word forms and the student must correct a mistake. Once all words are formed, the student clicks “submit” to send the score to his or her teacher. This marks the end of Activity 1. (See FIG. 4).

Step 4:

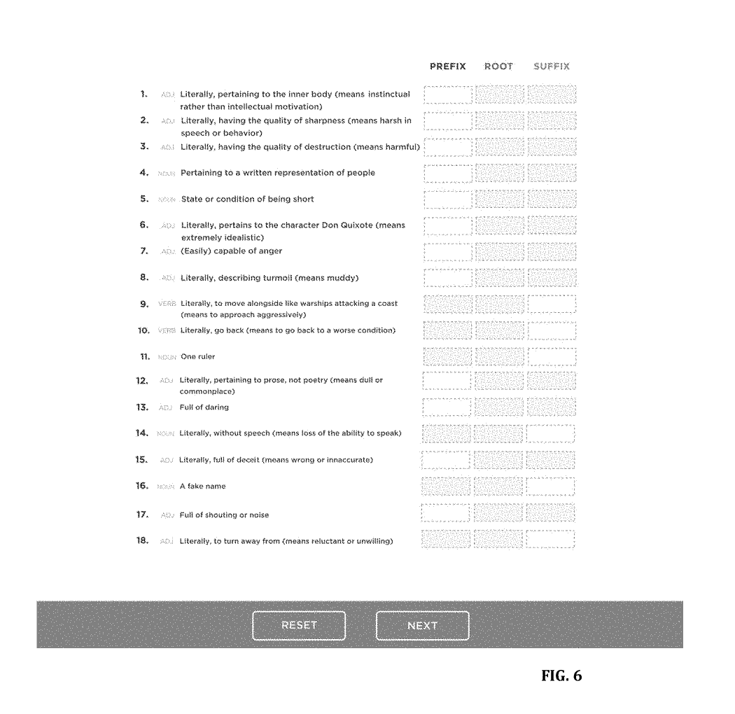

Following Activity 1, which specifically tests students on words with three parts, students move onto Activity 2. Activity 2 contains words that have only two Latin or Greek prefixes, roots or suffixes. Everything else in terms of functionality remains the same. (See FIGS. 5 and 6).

Step 5:

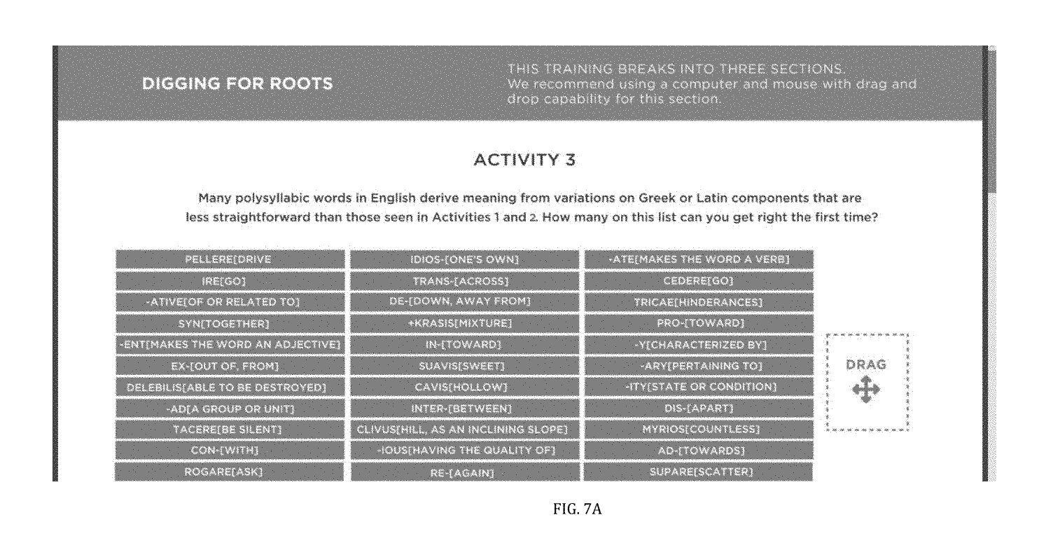

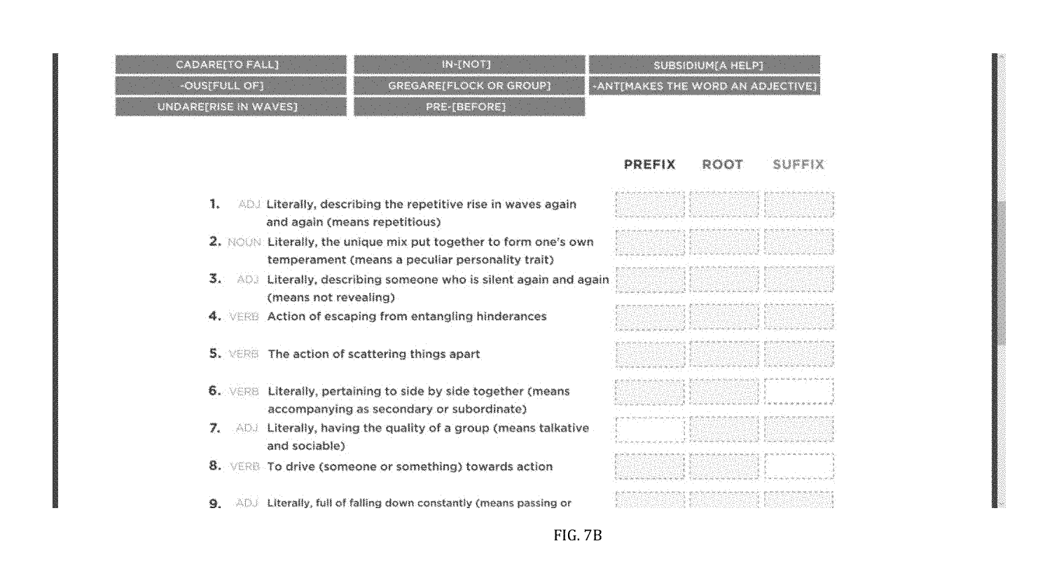

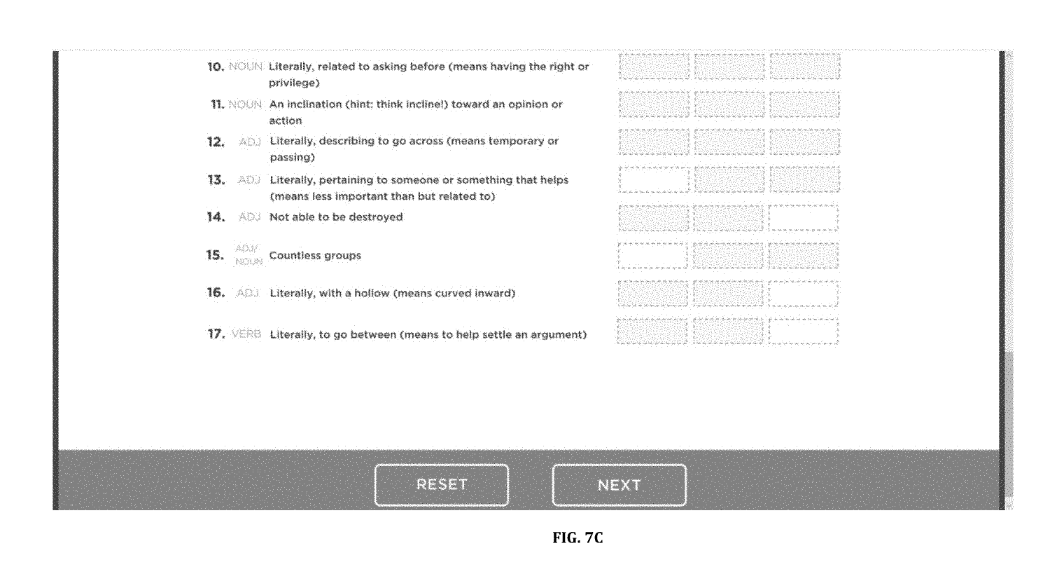

Following Activity 2, students move onto Activity 3. This is where GATE tests them on slightly harder two- and three-part words. For example, in contrast to the straightforward “vol” root for “benevolent,” students must match roots like “undare” to “redundant.” All functionality remains the same compared to the previous activities, however. (see FIGS. 7A, 7B and 7C).

Step 6:

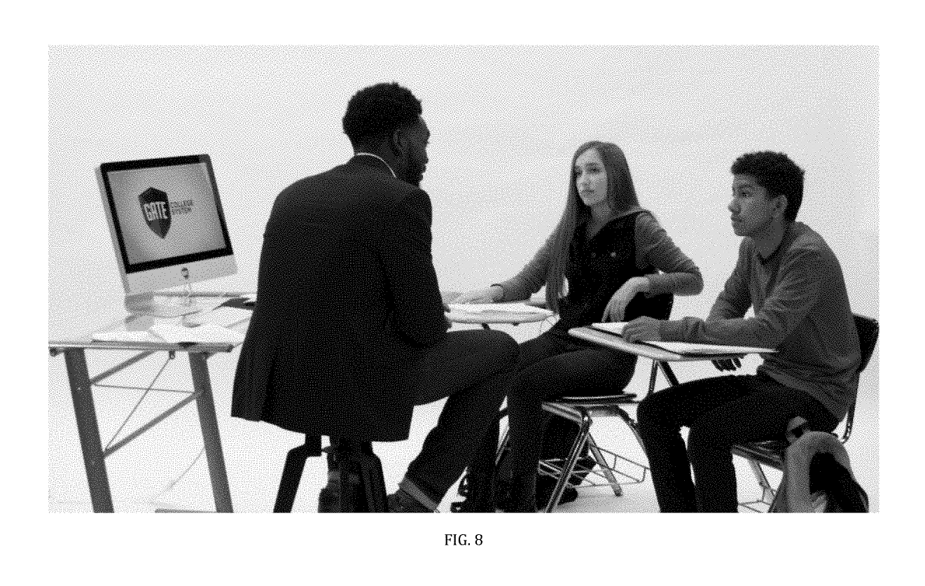

Once all three activities are complete, students are then presented with a video which explains the usage of GATE's carefully curated 2,000 Must-Know Vocabulary List. FIG. 8 is a screenshot of the video to show the classroom-style way in which the 2,000 Must-Know activity is taught.

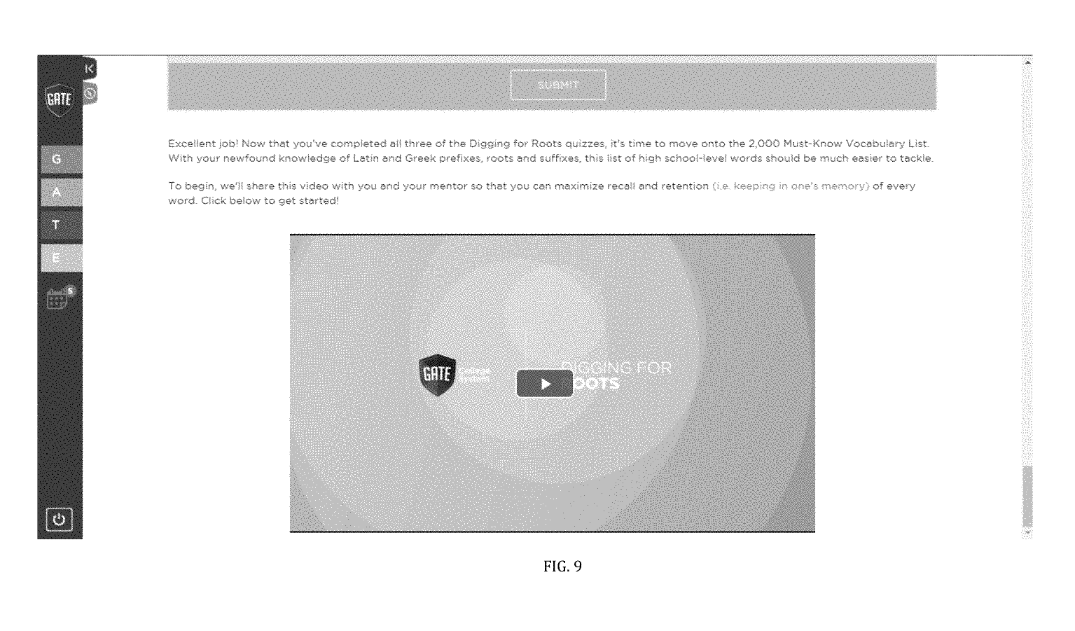

With the help of their teachers or mentors, students will practice the lists within the document, presented in sets of 20. As part of a game for practice with a peer, students are asked to fit as many of the 20 words into a sentence as possible, using them in the correct form with the correct meaning. Also, students will prepare flashcards for every word, writing the word itself on the front and the part of speech and definition on the back. Each time they successfully recall the meaning of a word using its flashcard, it is placed on a pile separately from those words they could not successfully remember, called the NOT-A-CLUE pile. Students must continuously review their NOT-A-CLUE pile until they have successfully mastered all words. (See FIG. 9)

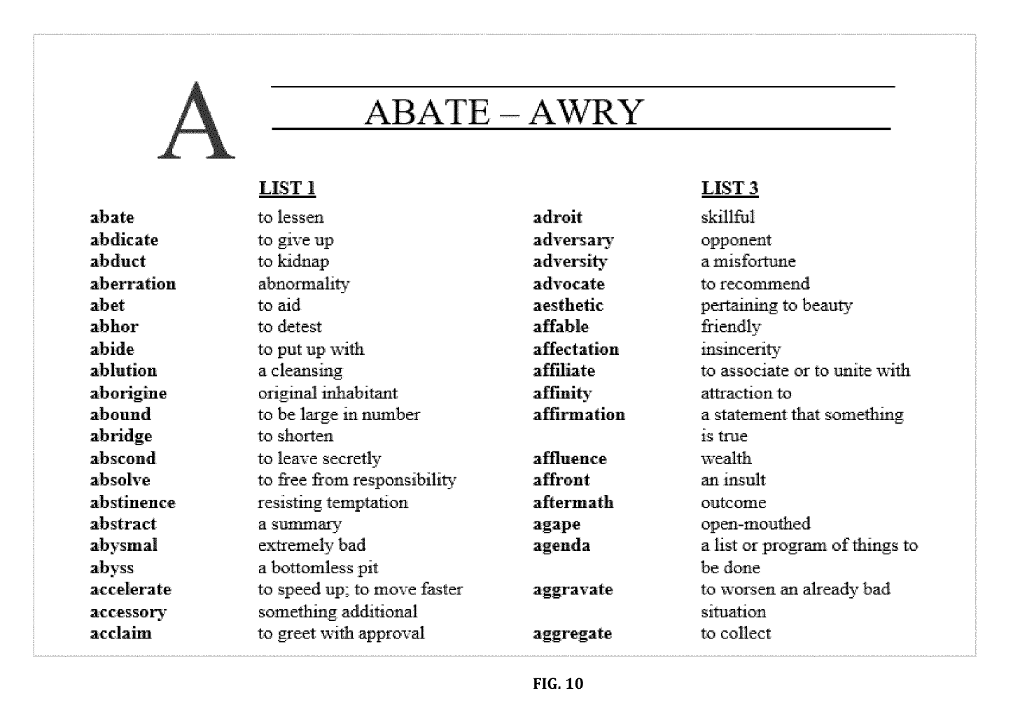

FIG. 10 is a screenshot showing the beginning of the 2,000 Must-Know Vocabulary List, broken into sets of 20 words at a time.

Step 7:

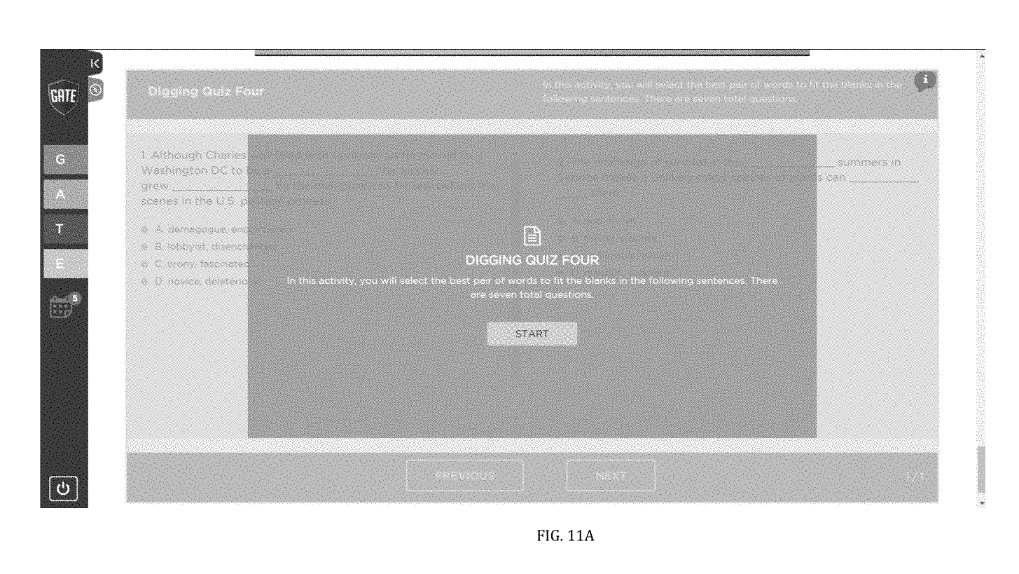

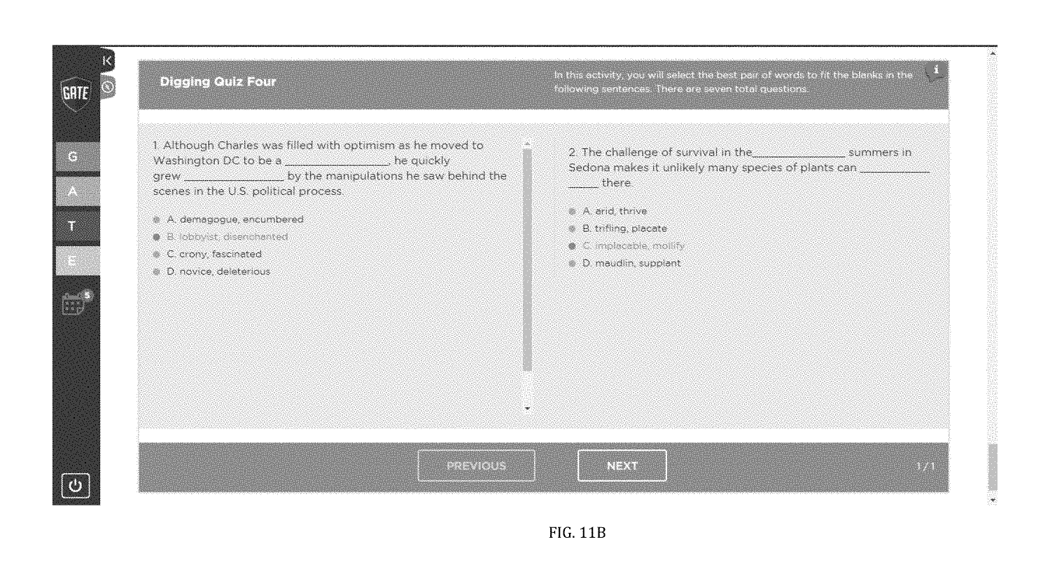

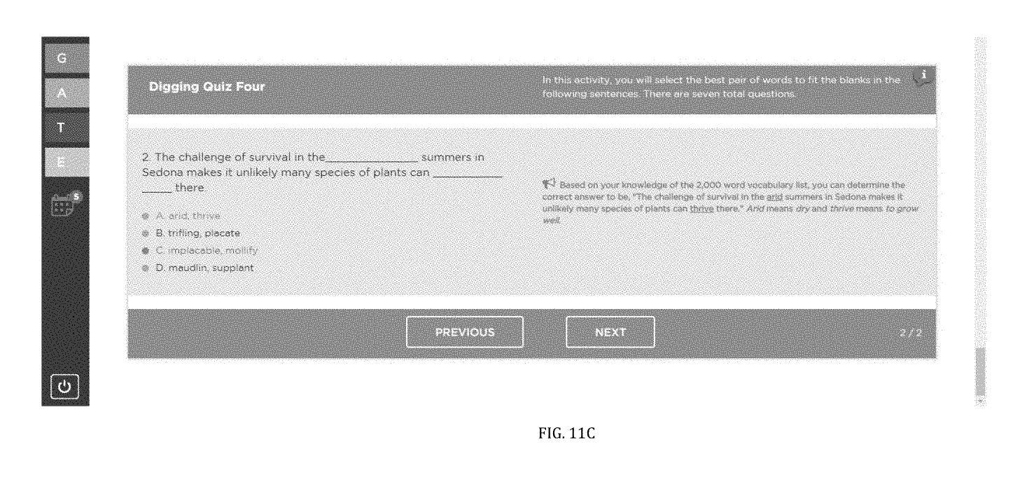

Once students have mastered their written flashcards, they then complete the activities related specifically to the 2,000 words. This includes a fill-in-the-blank quiz as shown in FIGS. 11A-C.

In one embodiment, the Digging for Roots methodology includes the curricular elements that flow after the drag and drop game, as these together comprise the pedagogy for this portion of the student platform.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

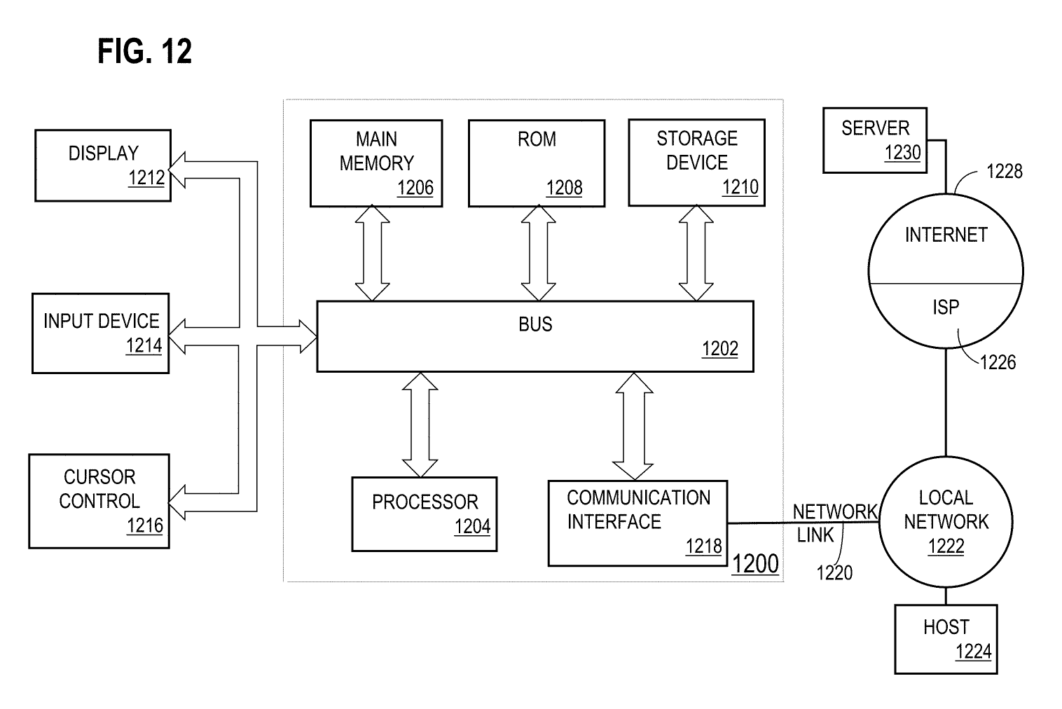

For example, FIG. 12 is a block diagram that illustrates a computer system 1200 upon which an embodiment of the invention may be implemented. Computer system 1200 includes a bus 1202 or other communication mechanism for communicating information, and a hardware processor 1204 coupled with bus 1202 for processing information. Hardware processor 1204 may be, for example, a general purpose microprocessor.

Computer system 1200 also includes a main memory 1206, such as a random access memory (RAM) or other dynamic storage device, coupled to bus 1202 for storing information and instructions to be executed by processor 1204. Main memory 1206 also may be used for storing temporary variables or other intermediate information during execution of instructions to be executed by processor 1204. Such instructions, when stored in non-transitory storage media accessible to processor 1204, render computer system 1200 into a special-purpose machine that is customized to perform the operations specified in the instructions.

Computer system 1200 further includes a read only memory (ROM) 1208 or other static storage device coupled to bus 1202 for storing static information and instructions for processor 1204. A storage device 1210, such as a magnetic disk, optical disk, or solid-state drive is provided and coupled to bus 1202 for storing information and instructions.

Computer system 1200 may be coupled via bus 1202 to a display 1212, such as a cathode ray tube (CRT), for displaying information to a computer user. An input device 1214, including alphanumeric and other keys, is coupled to bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane.

Computer system 1200 may implement the techniques described herein using customized hard-wired logic, one or more ASICs or FPGAs, firmware and/or program logic which in combination with the computer system causes or programs computer system 1200 to be a special-purpose machine. According to one embodiment, the techniques herein are performed by computer system 1200 in response to processor 1204 executing one or more sequences of one or more instructions contained in main memory 1206. Such instructions may be read into main memory 1206 from another storage medium, such as storage device 1210. Execution of the sequences of instructions contained in main memory 1206 causes processor 1204 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1210. Volatile media includes dynamic memory, such as main memory 1206. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1202. Transmission media can also take the form of acoustic or light waves, such as those generated during radio-wave and infra-red data communications.

Various forms of media may be involved in carrying one or more sequences of one or more instructions to processor 1204 for execution. For example, the instructions may initially be carried on a magnetic disk or solid-state drive of a remote computer. The remote computer can load the instructions into its dynamic memory and send the instructions over a telephone line using a modem. A modem local to computer system 1200 can receive the data on the telephone line and use an infra-red transmitter to convert the data to an infra-red signal. An infra-red detector can receive the data carried in the infra-red signal and appropriate circuitry can place the data on bus 1202. Bus 1202 carries the data to main memory 1206, from which processor 1204 retrieves and executes the instructions. The instructions received by main memory 1206 may optionally be stored on storage device 1210 either before or after execution by processor 1204.

Computer system 1200 also includes a communication interface 1218 coupled to bus 1202. Communication interface 1218 provides a two-way data communication coupling to a network link 1220 that is connected to a local network 1222. For example, communication interface 1218 may be an integrated services digital network (ISDN) card, cable modem, satellite modem, or a modem to provide a data communication connection to a corresponding type of telephone line. As another example, communication interface 1218 may be a local area network (LAN) card to provide a data communication connection to a compatible LAN. Wireless links may also be implemented. In any such implementation, communication interface 1218 sends and receives electrical, electromagnetic or optical signals that carry digital data streams representing various types of information.

Network link 1220 typically provides data communication through one or more networks to other data devices. For example, network link 1220 may provide a connection through local network 1222 to a host computer 1224 or to data equipment operated by an Internet Service Provider (ISP) 1226. ISP 1226 in turn provides data communication services through the world wide packet data communication network now commonly referred to as the “Internet” 1228. Local network 1222 and Internet 1228 both use electrical, electromagnetic or optical signals that carry digital data streams. The signals through the various networks and the signals on network link 1220 and through communication interface 1218, which carry the digital data to and from computer system 1200, are example forms of transmission media.

Computer system 1200 can send messages and receive data, including program code, through the network(s), network link 1220 and communication interface 1218. In the Internet example, a server 1230 might transmit a requested code for an application program through Internet 1228, ISP 1226, local network 1222 and communication interface 1218.

The received code may be executed by processor 1204 as it is received, and/or stored in storage device 1210, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method for improving use of a computer system as a tool for teaching language, comprising:
presenting on a display device of a computer system, as part of a first automated activity, a definition of a particular word without depicting the particular word itself;
presenting, on the display device of the computer system, a plurality of draggable prefixes, roots and suffixes that belong to the particular word;
establishing a first position, on the screen display, to which a user may drag one of the draggable prefixes;
establishing a second position, on the screen display, to which the user may drag one of the draggable roots;
establishing a third position, on the screen display, to which the user may drag one of the draggable suffixes;
in response to the user dragging a particular draggable prefix to the first position, dragging a particular draggable root to the second position, and dragging a particular suffix to the third position, determining whether the particular word is formed by combining the particular draggable prefix, the particular draggable root, and the particular draggable suffix;
generating an indication of success, by the computer system, in response to determining that the particular word is formed by combining the particular draggable prefix, the particular draggable root, and the particular draggable suffix.

2. The method of claim 1 wherein generating the indication of success includes displaying the particular word formed by combining the particular draggable prefix, the particular draggable root, and the particular draggable suffix.

3. The method of claim 1 further comprising, after completion of the first automated activity, performing a second automated activity in which the user combines draggable prefixes, draggable roots and draggable suffixes to form words that have only two word parts selected from a set of word parts consisting of: prefixes, roots, and suffixes.

4. The method of claim 3 further comprising, after completion of the second automated activity, performing a third automated activity in which the user combines draggable prefixes, draggable roots and draggable suffixes to form one or more words that have two word parts, and one or more words that have three word parts, selected from a set of word parts consisting of: prefixes, roots, and suffixes.

5. The method of claim 4 further comprising, after completion of the third automated activity, causing the user to participate in a fourth activity in which the user fits as many words, from a particular vocabulary list, into a single sentence.
